(19) United States
(12) Patent Application Publication
(10) Pub. No.: US 2008/0049342 A1
(43) Pub. Date: Feb. 28, 2008

(54) Balanced Radiation Concentrating Device

(76) Inventor: David Timothy Dobney, Toronto (CA)

Correspondence Address: David Dobney, 137 Grenadier Road, Toronto, ON, M6R 1R5, US

(21) Appl. No.: 11/466,836

(22) Filed: Aug. 24, 2006

(51) Int. Cl. G02B 5/10

(52) U.S. Cl. 359/853

(57) ABSTRACT

A balanced radiation concentrating device used to focus radiation from a moving source onto a stationary receiver is disclosed. The primary application of such an invention relates to concentrating the radiation from the sun onto a stationary target. In such an application the device may be termed a “ganged heliostat”, which is an array of mirrors controlled by a common positioning mechanism such that each mirror reflects light from the sun onto a stationary target. The design of the device is greatly simplified in comparison to ganged heliostats of the prior art. One major improvement included in the present invention as compared to devices of the prior art is the balancing feature.

### RELATED APPLICATIONS

This utility application claims some of the benefits of pending U.S. patent application Ser. No. 11/425,487 filed Jun. 21, 2006 by David Dobney.

### BACKGROUND OF THE INVENTION

The present invention relates to a balanced radiation concentrating device used to focus radiation from a moving source onto a stationary receiver.

The primary application of such an invention relates to concentrating the radiation from the sun onto a stationary target. In such an application the device may be termed a “ganged heliostat”, which is an array of mirrors controlled by a common positioning mechanism such that each mirror reflects light from the sun onto a stationary target.

In other applications, the device may be used to concentrate electromagnetic radiation such as radio signals.

### PRIOR ART

A prior art exists in solar radiation concentrating devices that includes “non-ganged” devices such as fresnel lenses, parabolic dishes, parabolic troughs, and conventional heliostats. A number of factors impose limitations on such devices. In general, since these devices are not ganged, a positioning mechanism is required for every reflective element in the system. Such a requirement increases the cost of the device. The height of these types of concentrating devices is significantly greater than other designs (such as the present invention) and as such, the devices are susceptible to damage by wind loads or must be supported by a structure that is expensive. In the case of curved or parabolic mirror devices, a significant expense is also incurred in producing curved mirror shapes sufficiently precise for use in radiation concentration.

A prior art exists in radiation concentrating devices that are ganged. In solar applications, these devices may be termed as “ganged heliostats”. Prior art of ganged heliostats includes devices disclosed in U.S. Pat. No. 4,110,010 (Hilton), U.S. Pat. No. 4,056,313 (Arbogast) and U.S. Pat. No. 3,466,119 (Francia). A number of factors impose limitations on such devices. These devices include a much higher number of parts and a higher complexity of parts than the present invention, and as such are more expensive to produce. Also, various ganged heliostats of the prior art (e.g. U.S. Pat. No. 4,110,010) require daily adjustment to compensate for the declination of the sun. Such a requirement increases operating cost of the device and the likelihood of focusing errors. Continual adjustment to compensate for solar declination is not required of the present device.

The pending U.S. patent application Ser. No. 11/425,487 (Dobney) discloses a “Radiation Concentrating Device” of the ganged type which includes several improvements over the devices of the prior art mentioned above. The present invention includes several improvements over the prior art and the device of pending U.S. patent application Ser. No. 11/425,487 (Dobney), among which is the balancing feature.

### BRIEF SUMMARY OF THE INVENTION

The present invention relates to a balanced radiation concentrating device that can be arranged in a ganged array of identical modules each including a mirror for reflecting incident radiation from a moving radiation source to a stationary receiver.

The device includes an aiming means that is continually adjusted in response to the movement of the radiation source; said aiming means indirectly causes guides of the device to be aimed at the radiation source.

The device also includes an aiming means that is adjusted one time only based on the position of the stationary receiver relative to the device; said aiming means indirectly causes guides of the device to be aimed at the stationary receiver.

Each module includes guides that align parts along the incidence vector (i.e.—a vector through the mirror centre and the source of radiation). Each module also contains guides that align parts along the reflection vector (i.e.—a vector through the mirror centre and the stationary receiver).

Each module includes a set of interconnection parts that are used to interconnect the guides to a mirror frame which is rigidly connected to the mirror. The design of the guides, interconnection parts, and mirror frame all represent major simplifications or improvements inherent in the present invention as compared to ganged heliostat designs of the prior art. Together the guides, interconnection parts, and mirror frame achieve the mirror position necessary to reflect incident radiation to a stationary receiver.

The device also includes a fixed frame for mounting all of the above mentioned parts.

The advantages of the present invention will be more apparent from the following detailed description in reference to the accompanying drawings.

### DESCRIPTION OF THE DRAWINGS

FIG. 1 is a conceptual elevation view of an embodiment of the device in relation to the source of radiation and the receiver, which indicates the orientation of the reflective surfaces of the device relative to incident radiation and reflected radiation.

FIG. 2 is a plan view of selected parts of an embodiment of the present invention wherein the view includes only the mirrors, stationary frame, and various aiming means

FIG. 3 is a typical elevation view of a module of the device of FIG. 2 taken along the line 3-3

FIG. 4 is a typical elevation view of selected parts of a module of the device of FIG. 2 taken along the line 4-4

FIG. 5 is a plan view of selected parts of the module of FIG. 3 taken along the line 5-5

FIG. 6 is an elevation view of selected parts of FIG. 5 taken along the line 6-6

FIG. 7 is an elevation view of selected parts of FIG. 5 taken along the line 7-7

FIG. 8 is an elevation view of selected parts of FIG. 5 taken along the line 8-8

FIG. 9 is a conceptual view of two dimensional elements analogous to the interconnection parts of a module of the device of FIG. 2

FIG. 10 is an elevation view of the incidence aiming means of the device of FIG. 2 taken along the line 10-10

FIG. 11 is a plan view of the parts shown in FIG. 10 taken along the line 11-11

FIG. 12 is an elevation view of the parts shown in FIG. 10 taken along the line 12-12

FIG. 13 is an elevation view of the reflection aiming means of the device of FIG. 2 taken along the line 13-13

FIG. 14 is a plan view of the parts shown in FIG. 13 taken along the line 14-14

FIG. 15 is an elevation view of the parts shown in FIG. 13 taken along the line 15-15

FIG. 16 is a typical elevation view of an alternative reflection aiming means

FIG. 17 is a plan view of the parts shown in FIG. 16 taken along the line 17-17.

FIG. 18 is an elevation view of the parts shown in FIG. 16 taken along the line 18-18

### DETAILED DESCRIPTION OF USEFUL EMBODIMENTS OF THE INVENTION

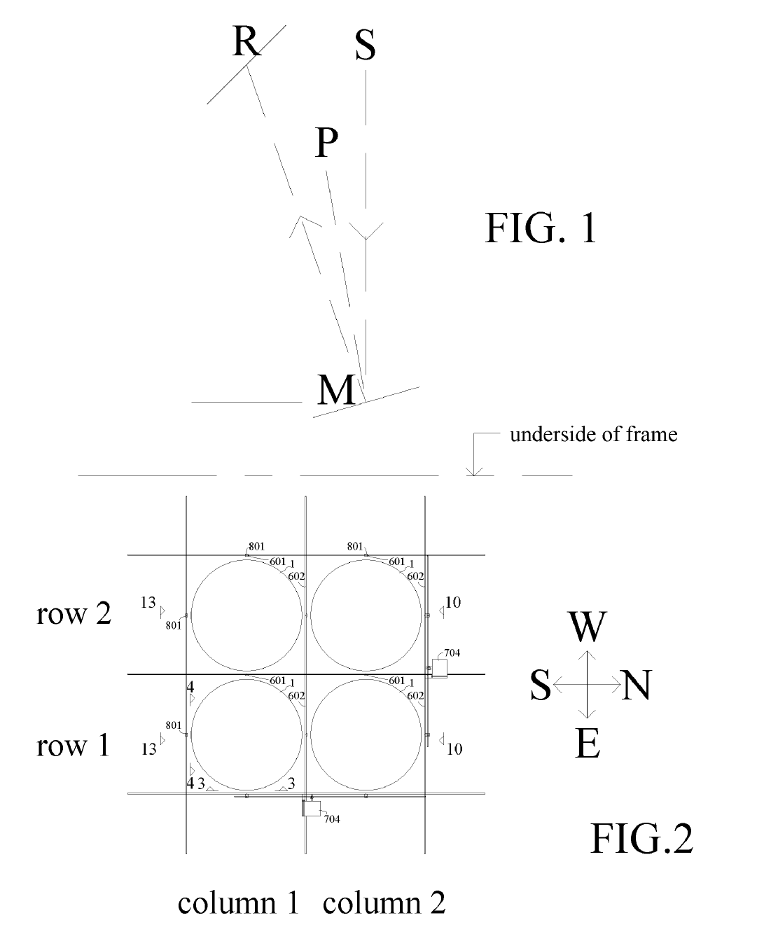

An embodiment of the invention will be described in reference to FIGS. 1 through 15. The embodiment considered is an array of reflective surfaces, or mirrors 1, arranged in 2 rows and 2 columns. Other embodiments of the invention may include an arbitrary number of rows and columns (and hence an arbitrary number of mirrors 1). The members of the stationary frame of the device (i.e. posts 601 and cross-members 602) shown in FIGS. 2 through 14 are aligned along North-South and East-West axes. This alignment has been selected to simplify the detailed description of the device. Other embodiments of the device may be oriented at arbitrary angles to the North-South and East-West axes and retain the same functionality.

FIG. 1 shows a conceptual view of various mirrors 1 of the array in relation to the source of radiation and the stationary receiver. Referring to FIG. 1, radiation from a source at point S is incident on a mirror at point M and reflected rays are directed towards a receiver at point R. When radiation is focused onto the receiver, a unique point P exists for each mirror 1 in the array such that the line MP is normal (or perpendicular) to the surface of the mirror and the following condition is met: angle PMR=angle SMP. Another way of stating this condition is that vector MP bisects the angle SMR. Yet another way of stating this condition is that the normal of the mirror 1, the vector MN, must lie in the plane of MR and MS, as well as a plane that bisects the angle SMR.

The vector MS will be referred to as the incidence vector. The vector MR will be referred to as the reflection vector.

FIG. 2 shows a plan view of various major components of the device. The device includes an array of similar units, or modules, each including a mirror 1.

Located at the North end of the array is an actuator 704 used to move parts of the device in response to the apparent motion of the radiation source along the E-W axis. Located at the East end of the array is an actuator 704 used to move parts of the device in response to the apparent motion of the radiation source along the N-S axis. Located at the South end of the array is a group of collars 801 which are adjusted one time only, depending on the apparent position of the receiver along the E-W axis relative to the array. Located at the West end of the array is a group of collars 801 which are adjusted one time only, depending on the apparent position of the receiver along the N-S axis relative to the array.

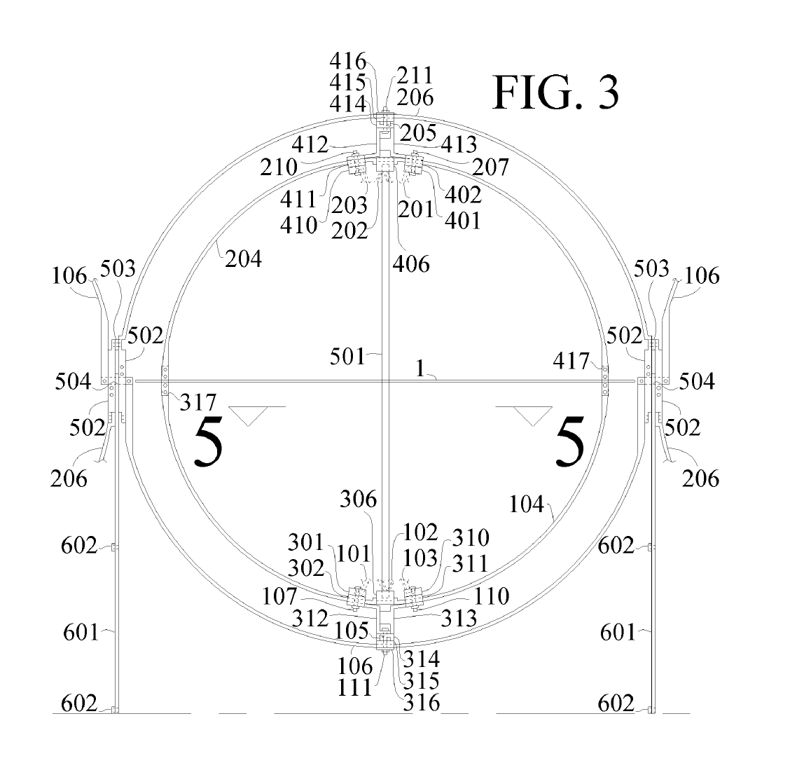

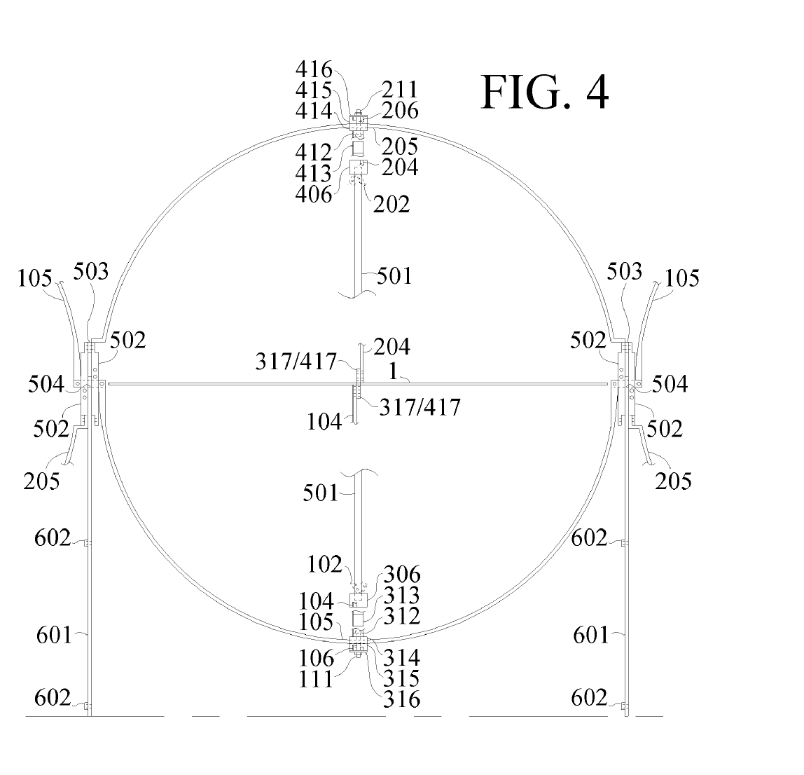

Refer to FIGS. 3 and 4 for detailed elevation views of the guides, interconnection parts, and mirror frame directly manipulating the mirror 1 located in the South-East corner of the array (i.e.—the module of row 1 and column 1 as indicated in FIG. 2).

A semicircular element that constitutes guide 106 is rotated about a N-S axis collinear with the centre of the mirror 1. A semicircular element that constitutes guide 105 is rotated about an E-W axis collinear with the centre of the mirror 1. Guides 106 and 105 are adjusted such that the central axis of bolt 111 is collinear with a line from the centre of the mirror to the receiver (i.e.—the reflection vector). In the capacity that guides 106 and 105 aim at the reflection vector, they may be referred to as reflection guides. The method used to adjust, or aim, the guides, which is referred to as the reflection aiming means, will be discussed later.

A semicircular element that constitutes guide 206 is rotated about a N-S axis collinear with the centre of the mirror 1. A semicircular element that constitutes guide 205 is rotated about an E-W axis collinear with the centre of the mirror 1. Guides 206 and 205 are adjusted such that the central axis of bolt 211 is collinear with a line from the centre of the mirror to the source of radiation (i.e.—the incidence vector). In the capacity that guides 206 and 205 aim at the incidence vector, they may be referred to as incidence guides. The method used to adjust, or aim, the guides, which is referred to as the incidence aiming means, will be discussed later.

Additional nomenclature is given to the guides. The guides located above the mirror in any module may be referred to as the upper guides. The guides located below the mirror in any module may be referred to as the lower guides. In the module of the South-East corner of the array (i.e.—row 1 and column 1 of FIG. 2, corresponding to the module shown in detail in FIGS. 3 and 4) the incidence guides are the upper guides and the reflection guides are the lower guides. In other modules of the array, the incidence guides may be lower guides and conversely the reflection guides may be upper guides.

Each of parts 101, 102, 103 as well as parts 201, 202, 203 is an arc with a centre of curvature at the centre of mirror 1. Arcs located below the mirror (e.g.—the arcs 101, 102, 103 of the module of the South-East corner of the array) may be referred to as lower arcs. Arcs located above the mirror (e.g.—arcs 201, 202, 203 of the module of the South-East corner of the array) may be referred to as upper arcs. Note that the arcs as shown in FIGS. 3 and 4 are a conceptual representation only.

One end of shaft 501 passes through clip 306, and is bolted to arc 102. The other end of shaft 501 passes through clip 406 and is bolted to arc 202. Shaft 501 passes through an opening in the centre of the mirror 1. Shaft 501 may be referred to as the kingpin. The arcs and kingpin may be collectively referred to as the interconnection parts.

Each of parts 104 and 204 are semicircular and are rigidly fastened to the mirror 1, and each other, using fasteners 317 and 417. Parts 104 and 204 constitute the mirror frame.

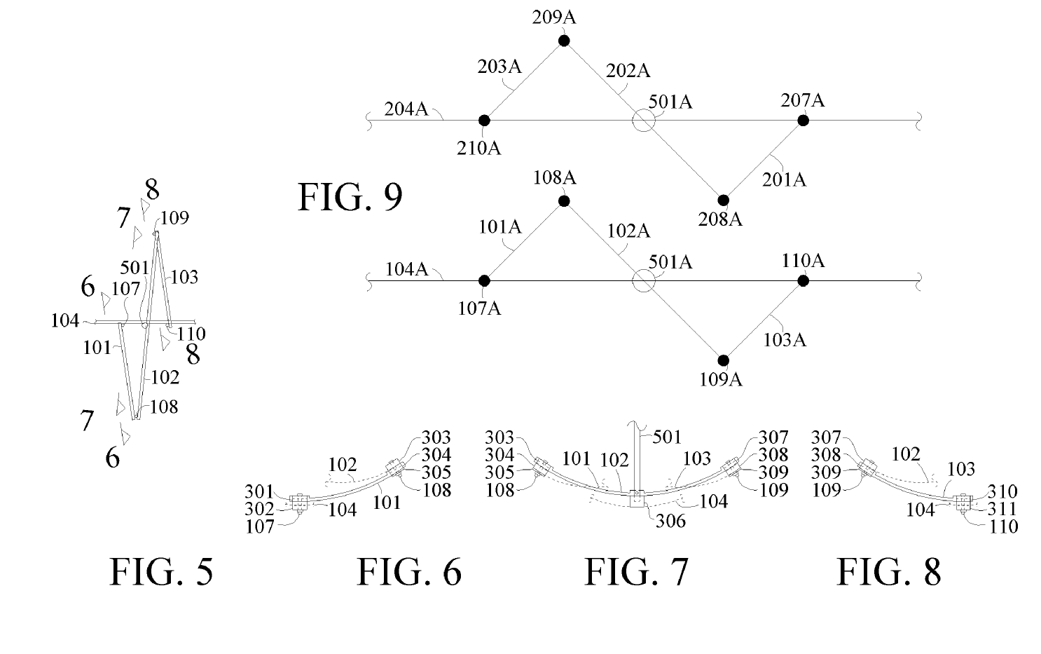

Refer to FIGS. 5, 6, 7, and 8 for detailed views of the lower arcs and related bolts, clips, and fasteners of the module of FIG. 3. The upper arcs of the device are similar. Note that arcs 102 and 104 as shown in FIG. 5 are a conceptual representation only. Note that arcs 101, 103 and 104 as shown in FIG. 6 are a conceptual representation only. Note that arcs 102 and 104 as shown in FIG. 7 are a conceptual representation only.

Refer to FIG. 9, which is a conceptual view of two dimensional elements analogous to the interconnection parts of the module of FIGS. 3 and 4. Part 101A is analogous to part 101, part 102A is analogous to part 102, etc. The two dimensional analogy can be useful in understanding the operation of the device. The elements of the two dimensional analogy of FIG. 9 operate on a flat surface in the same manner that the interconnection parts of each module operate on a spherical surface. The lengths of parts 101A, 103A, 201A, and 203A are identical. The lengths of parts 102A and 202A are identical. Similarly, the angular lengths of parts 101, 103, 201, and 203 are identical. The angular lengths of parts 102 and 202 are identical.

It should be noted that the guides, arcs, and mirror frame are composed of flat pieces and the kingpin is rod shaped. As such the aforementioned parts may be relatively easily fabricated.

The following is a description of the relationship between the mirror frame, the kingpin, the interconnection parts, and the guides.

Kingpin 501 is fastened to arcs 102 and 202. Kingpin 501 is coupled to the centre of mirror frame parts 104 and 204 using clips 306 and 406 respectively, such that the central axis of kingpin 501 is always perpendicular to the mirror 1.

Arc 101 is coupled to one end of arc 102 using bolt 108. Arc 103 is coupled to the other end of arc 102 using bolt 109. Arc 101 is coupled to the mirror frame part 104 using bolt 107. Arc 103 is coupled to the mirror frame part 104 using bolt 110.

Arc 201 is coupled to one end of arc 202 using bolt 208. Arc 203 is coupled to the other end of arc 202 using bolt 209. Arc 201 is coupled to the mirror frame part 204 using bolt 207. Arc 203 is coupled to the mirror frame part 204 using bolt 210.

Part 312, 313, 412, and 413 are coplanar with the mirror frame. Part 312 links bolt 107 to bolt 111. Part 412 links bolt 210 to bolt 211. Parts 312, 313, 412, and 413 may be referred to as standoffs in the capacity that they offset the axes of a pair of bolts.

Due to the above mentioned geometry of the kingpin, mirror frame, arcs, and standoffs, the bolts 111 and 211 will always be offset from the kingpin an equal angular distance. The mirror frame lies in a plane coplanar with bolts 111 and 211. As mentioned above, bolt 111 is collinear with the reflection vector, or vector MR of FIG. 1, and bolt 211 is aligned with the incidence vector, or vector SM of FIG. 1. Therefore the kingpin is coplanar with vector MR and MS. Since the kingpin is offset an equal angular distance from vector MR and MS, it bisects the angle SMR. Since the kingpin is coplanar with vector MR and MS and bisects the angle SMR, it is coincident with the vector MN, thus positioning of the mirror is achieved.

The following is a description of the balancing feature of the device. In order to describe the feature, a clarification of terminology relating to balancing is required. All interconnection parts in each module of the device are balanced. For any part to be balanced it must be a member of a group of parts wherein said group has a centre of mass that always coincides with the centre of the mirror 1. Balanced parts impart a net zero torque about the axes of rotation of the guides of the device, which is beneficial in reducing guide size.

Arc 101 is balanced by arc 201. The bolts and clips related to arc 101 are balanced by the bolts and clips related to arc 201. Bolt 107 passes through clips 301 and 302 which are coupled to arc 101 and mirror frame part 104 respectively. Bolt 207 passes through clips 401 and 402 which are coupled to arc 201 and mirror frame part 204 respectively. Bolt 107 and clips 301 and 302 are balanced by bolt 207 and clips 401 and 402. Bolt 108 and clips 303, 304, and 305 are similarly balanced by parts related to arc 201.

Arc 103 is balanced by arc 203. The bolts and clips related to arc 103 are balanced by the bolts and clips related to arc 203. Bolt 110 passes through clips 310 and 311 which are coupled to arc 103 and mirror frame part 104 respectively. Bolt 210 passes through clips 410 and 411 which are coupled to arc 203 and mirror frame part 204 respectively. Bolt 110 and clips 310 and 311 are balanced by bolt 210 and clips 410 and 411. Bolt 109 and clips 307, 308, and 309 are similarly balanced by parts related to arc 203.

Arc 102 is balanced by arc 202. The bolts and clips related to arc 102 are balanced by the bolts and clips related to arc 202. Clip 306 is balanced by clip 406.

The mirror frame parts 104 and 204 and related fasteners 317 and 417 are balanced. The kingpin 501 is balanced. The mirror 1 is balanced.

Standoff 412, clip 414 and 415, and bolt 211 are balanced by standoff 313. Standoff 312, clip 314 and 315, and bolt 111 are balanced by standoff 413.

In the embodiment described above, all interconnection parts and related parts are balanced. However in other embodiments, it is possible to revise the design of the device such that certain unbalanced parts are permitted for the benefit of ease of fabrication. Such a design revision may be done without parting from the spirit of the invention as clarified by the claims below.

The following is a description of the parts of the device used to adjust guides 205 and 206 such that the central axis of bolt 211 is collinear with the incidence vector.

Referring to FIG. 3, guide 206 is bolted (at either end) to parts 502. Rod 504 passes through a hole in part 502. Washer 503 acts as a spacer between adjoining parts 502 of adjacent modules. Guides 206 of adjacent modules in a common row are attached to parts 502, said connection causing all guides 206 in a given row to be rotated at the same angle about the axis of rods 504.

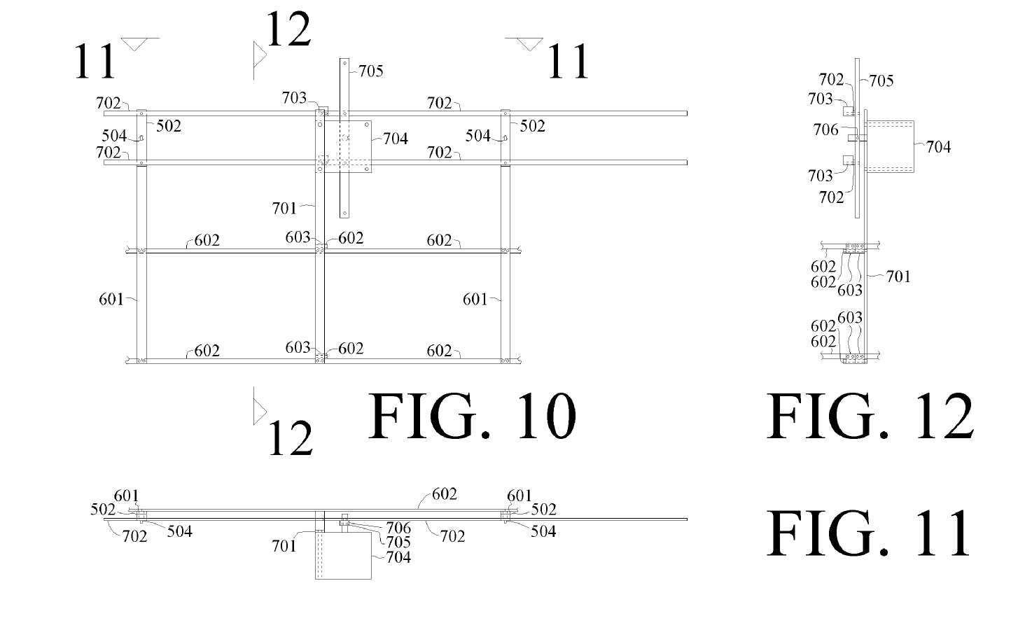

Refer to FIGS. 10, 11, and 12. At the northern end of the array, guide 206 is bolted to parts 502. Part 502 is bolted to linkages 702. Linkages 702 are bolted to part 705. Part 705 is connected to the shaft of actuator 704 by means of a set screw 706. Actuator 704 is mounted on post 701 which is fixed to the stationary frame. As the shaft of actuator 704 turns, linkages 702 are moved and thus parts 502 and guides 206 are rotated about the central axis of rods 504.

It should be noted that the bolt-hole to bolt-hole length of linkage 702 equals the distance between the central axes of rods 101 of adjacent modules. Thus, the guides 206 of every module of the device will be inclined at the same angle. Inclining every guide 206 at the same angle is allowable since the source of radiation is generally sufficiently distant from the device for the intended applications.

Guide 205 is adjusted in a similar fashion as described above, using the actuator 704 and related parts at the eastern end of the array. The parts of the device used to adjust the incidence guides are referred to as the incidence aiming means.

The following is a description of the parts of the device used to adjust guides 105 and 106 such that bolt 111 is collinear with the reflection vector.

Referring to FIG. 3, the guide 106 is bolted (at either end) to rods 504. Guides 106 of adjacent modules in a common row are attached to rods 504, said connection causing all guides 106 in a row to be rotated at the same angle about the axis of rods 504.

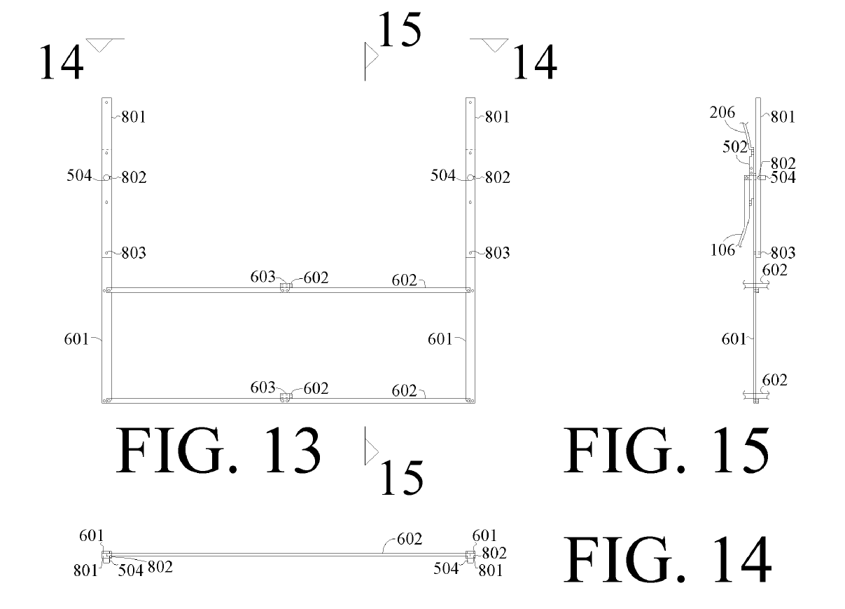

Refer to FIGS. 13, 14, and 15. At the southern end of the array, guide 106 is bolted to rod 504. Rod 504 is rigidly fixed within a hole in collar 801 by means of a set screw 802. Collar 801 is rigidly fixed to post 601 of the stationary frame using bolt 803. Thus rod 504 and guides 106 of a given row may be oriented at a desired angle of inclination about the central axis of rod 504. Each row of the device is uniquely adjusted using collars 801 and set screws 802 such that the guides 106 of a given row are aligned along the reflection vector.

It should be noted that reflection guides of each row of the device will be adjusted at a unique angles of inclination. Such a feature is necessary since the receiver is generally relatively close to the array in the applications intended for the device.

Guide 105 is adjusted in a similar fashion as described above, using the collars 801, set screws 802 and related parts at the western end of the array. The parts of the device used to adjust the reflection guides are referred to as the reflection aiming means.

The following is a description of the arrangement of the guides of the device with respect to their overall centre of mass.

Referring to FIG. 3, guides 106 of adjacent modules in a given row are connected to each other via rod 504, said guides being disposed at an angle of 180 degrees about rod 504. Guides 206 of adjacent modules in a given row are connected via part 503, said guides being disposed at an angle of 180 degrees about rod 504. In the direction transverse to the section shown, the guides are connected in a similar manner.

Therefore, each pair of adjacent guides 106 in a row of the device has a centre of mass located on the central axis of rotation of guides 106. Each pair of adjacent guides 206 in a row of the device has a centre of mass located on the central axis of rotation of guides 206. Each pair of adjacent guides 105 in a column of the device has a centre of mass located on the central axis of rotation of guides 105. Each pair of adjacent guides 205 in a column of the device has a centre of mass located on the central axis of rotation of guides 205. This feature is similar to the balancing feature of the interconnection parts mentioned above, and is beneficial in reducing guide size. It should also be noted that the centre of mass of each pair of adjoining parts 503 is coincident with its central axis of rotation.

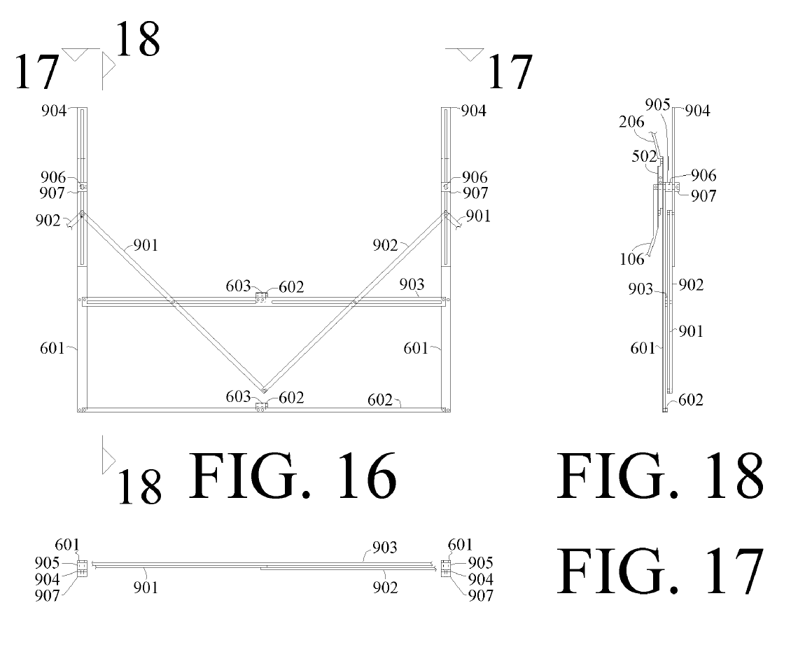

The following is a description of a reflection aiming means of an alternate embodiment of the device in reference to FIGS. 16, 17, and 18.

Guide 106 is bolted to rod 906. Rod 906 is keyed and fits through a space in rotating slotted part 904. Part 907 is fixed to rod 906 and retains rotating slotted part 904 on rod 906. Part 905 is a simple spacer located between rotating slotted part 904 and post 601 of the stationary frame. Stationary slotted part 903 is fixed to the stationary frame. A bolt passes through the midpoint of linkage 901, wherein said bolt moves in a slot of stationary slotted part 903. A bolt passes through the midpoint of linkage 902, wherein said bolt moves in a slot of stationary slotted part 903.

A bolt through one end of linkage 902 (i.e.—the bolt located below stationary slotted part 903) connects linkage 902 to linkage 901. A bolt through the other end of linkage 902 (i.e.—the bolt located above part 903) connects linkage 902 to linkage 901, wherein said bolt also passes through a slot in rotating slotted part 904. As ganged linkages 901 and 902 are moved laterally along the slot of stationary slotted part 903, all rotating slotted parts 904 and guides 106 are moved about their respective central axes, thus aiming of guides 106 along the reflection vector is achieved.

During initial installation of the device, linkages 901 and 902 are adjusted until all guides 106 are coplanar with their respective reflection vectors. After adjustments have been completed, linkages 901 and 902 are rigidly fixed in place.

Guides 105 are moved in a similar fashion by a similar apparatus in the transverse direction. A reflection aiming means of the type described in FIGS. 16, 17, and 18 is referred to as a ganged reflection aiming means.

I claim:

1. A balanced radiation concentrating device comprising:
a reflective surface or mirror for reflecting incident radiation from a moving radiation source to a stationary receiver;
a pair of upper guides and a pair of lower guides wherein:
said upper guides are located above said mirror;
said lower guides are located below said mirror
one of said pairs of guides are incidence guides wherein:
said incidence guides comprise a pair of semicircular elements;
said semicircular elements are mounted on mutually perpendicular shafts;
said semicircular elements are rotated about said shafts by an incidence aiming means;
said incidence guides provide a means to align parts of the device with the incidence vector;
one of said pairs of guides are reflection guides wherein:
said reflection guides comprise a pair of semicircular elements;
said semicircular elements are mounted on mutually perpendicular shafts;
said semicircular elements are rotated about said shafts by a reflection aiming means;
said reflection guides provide a means to align parts of the device with the reflection vector;
interconnection parts wherein:
said interconnection parts provide a means to align parts along the plane of the incidence and reflection vector;
said interconnection parts provide a means to align parts along the plane bisecting the angle between the incidence vector and the reflection vector;
said interconnection parts of said modules are balanced;
a mirror frame which is rigidly fixed to said mirror wherein said mirror frame is positioned by:
said interconnection parts aligned along a plane through the incidence vector and reflection vector;
said interconnection parts aligned along a plane bisecting the angle between the incidence vector and the reflection vector;
a stationary frame for mounting all of the above mentioned parts.

2. A device of claim 1 wherein:
said parts of the device are arranged in an array of identical modules;
said incidence guides are ganged wherein:
a plurality of said incidence guides are mounted on a plurality of primary axes wherein:
said primary axes are parallel;
said incidence guides are rotated about said primary axes by a primary incidence aiming means;
adjacent incidence guides mounted on any given primary axis are disposed at an angle of 180 degrees about said primary axis such that the overall centre of mass of said adjacent incidence guides is coincident with said primary axis;
a plurality of said incidence guides are mounted on a plurality of secondary axes wherein:
said secondary axes are parallel;
said incidence guides are rotated about said secondary axes by a secondary incidence aiming means;
adjacent incidence guides mounted on any given secondary axis are disposed at an angle of 180 degrees about said secondary axis such that the overall centre of mass of said adjacent incidence guides is coincident with said secondary axis;
said reflection guides of the device are ganged wherein:
a plurality of said reflection guides are mounted on a plurality of primary axes wherein:
said primary axes are parallel;
said reflection guides are rotated about said primary axes by a primary reflection aiming means;
adjacent reflection guides mounted on any given primary axis are disposed at an angle of 180 degrees about said primary axis such that the overall centre of mass of said adjacent reflection guides is coincident with said primary axis;
a plurality of said reflection guides are mounted on a plurality of secondary axes wherein:
said secondary axes are parallel;
said reflection guides are rotated about said secondary axes by a secondary reflection aiming means;
adjacent reflection guides mounted on any given secondary axis are disposed at an angle of 180 degrees about said secondary axis such that the overall centre of mass of said adjacent reflection guides is coincident with said secondary axis.

3. A device of claim 2 wherein said interconnection parts of each of said modules comprise:
a central rod or kingpin;
three lower arcs wherein:
said lower arcs are located below said mirror
said lower arcs have centres of curvature at the centre of said mirror
said lower arcs comprise a central lower arc, a left lower arc and a right lower arc wherein:
the centre of said central lower arc is fixed to said kingpin;
one end of said central lower arc is coupled to said left lower arc;
one end of said central lower arc is coupled to said right lower arc;
one end of said left lower arc is coupled to said mirror frame;
one end of said right lower arc is coupled to said mirror frame;
the angular lengths of said left lower arc and said right lower arc are equal;
three upper arcs wherein:
said upper arcs are located above said mirror
said upper arcs have centres of curvature at the centre of said mirror
said upper arcs comprise a central upper arc, a left upper arc and a right upper arc wherein:
the centre of said central upper arc is fixed to said kingpin such that said central upper arc balances said central lower arc;
one end of said central upper arc is coupled to said left upper arc;
one end of said central upper arc is coupled to said right upper arc;
one end of said left upper arc is coupled to said mirror frame;
one end of said right upper arc is coupled to said mirror frame;
the angular lengths of said left upper arc and said right upper arc are equal to the angular lengths of said left lower arc and said right lower arc;
the angular length of said central upper arc is equal to the angular length of said central lower arc;

4. A device of claim 2 wherein said mirror frame comprises a pair of mirror frame parts:
said mirror frame parts are semicircular and have a centre of curvature at the centre of said mirror;
said mirror frame parts are rigidly fixed to each other and rigidly fixed to said mirror;

5. A device of claim 2 wherein:
said primary incidence aiming means comprises a plurality of linkages wherein:
the bolt-hole to bolt-hole length of said linkages equals the overall length of said modules;
said linkages are connected to each row of said incidence guides thus ganging them;
said plurality of linkages are connected to a linear actuator wherein said linear actuator manually or automatically provides a linear motion thus providing a means for indirectly moving said rows of incidence guides;
said secondary incidence aiming means comprises a plurality of linkages wherein:
the bolt-hole to bolt-hole length of said linkages equals the overall length of said modules;
said linkages are connected to each column of said incidence guides thus ganging them;
said plurality of linkages are connected to a linear actuator wherein said linear actuator manually or automatically provides a linear motion thus providing a means for indirectly moving said columns of incidence guides;

6. A device of claim 2 wherein:
said primary reflection aiming means comprises a plurality of collars and set screws wherein:
each of said collars is fixed to a row of said reflection guides by means of said set screws thus providing a means to uniquely incline each row of said reflection guides;
said secondary reflection aiming means comprises a plurality of collars and set screws wherein:
each of said collars is fixed to row of said reflection guides by means of said set screws thus providing a means to uniquely incline each column of said reflection guides;

7. A device of claim 2 wherein:
said primary reflection aiming means is ganged and comprises:
a plurality of stationary slotted parts fixed to said stationary frame;
a plurality of rotating slotted parts coupled to each row of said reflection guides;
a plurality of linkages wherein:
said linkages are ganged to each other at their respective ends;
a bolt passes through the centre of each of said linkages;
said bolt passes through a slot of said stationary slotted parts such that said linkages may travel laterally along slots of said stationary slotted parts;
said linkages are coupled to said rotating slotted parts such that lateral motion of said linkages uniquely inclines each row of said reflection guides;
said secondary reflection aiming means is ganged and comprises:
a plurality of stationary slotted parts fixed to said stationary frame;
a plurality of rotating slotted parts coupled to each column of said reflection guides;
a plurality of linkages wherein:
said linkages are ganged to each other at their respective ends;
a bolt passes through the centre of each of said linkages;
said bolt passes through a slot of said stationary slotted parts such that said linkages may travel laterally along slots of said stationary slotted parts;
said linkages are coupled to said rotating slotted parts such that lateral motion of said linkages uniquely inclines each row of said reflection guides;
